(19) United States
(12) Patent Application Publication
(10) Pub. No.: US 2026/0172534 A1
(43) Pub. Date: Jun. 18, 2026

(54) IMAGE PROCESSING APPARATUS, IMAGE PROCESSING METHOD, AND RECORDING MEDIUM

(71) Applicant: Sony Group Corporation, Tokyo (JP)

(72) Inventors: Takaaki SUZUKI, Tokyo (JP); Noriaki TAKAHASHI, Tokyo (JP)

(73) Assignee: Sony Group Corporation, Tokyo (JP)

(21) Appl. No.: 18/725,145

(22) PCT Filed: Jun. 12, 2023
(86) PCT No.: PCT/JP2023/021694

§ 371 Date: Jun. 28, 2024

(30) Foreign Application Priority Data
Jun. 28, 2022 (JP) 2022-103293

(51) Int. Cl. H04N 13/106; G06T 3/4015; G06T 3/4053; G06T 5/70; H04N 13/194; H04N 13/305; H04N 13/383

(52) U.S. Cl. CPC H04N 13/106; G06T 3/4015; G06T 3/4053; G06T 5/70; H04N 13/194; H04N 13/305; H04N 13/383; G06T 2207/10012

(57) ABSTRACT

To implement system optimization. Provided is an image processing apparatus including a processing unit that performs processing in such a way that a processing load for a second signal related to a second stereoscopic image presented at a second viewpoint position away from a first viewpoint position is lower than a processing load for a first signal related to a first stereoscopic image presented at the first viewpoint position corresponding to a position of a user viewing a stereoscopic image in a real space, among a plurality of viewpoint positions which are relative positions with respect to a stereoscopic display configured to present a plurality of images as the stereoscopic image. The present disclosure can be applied to, for example, a stereoscopic display system.

### TECHNICAL FIELD

The present disclosure relates to an image processing apparatus, an image processing method, and a recording medium, and more particularly, to an image processing apparatus, an image processing method, and a recording medium that can implement system optimization.

### CROSS REFERENCE TO RELATED APPLICATIONS

This application claims the benefit of Japanese Priority Patent Application JP 2022-103293 filed on Jun. 28, 2022, the entire contents of which are incorporated herein by reference.

### BACKGROUND ART

In recent years, stereoscopic displays capable of presenting stereoscopic images have become widespread. A method using dedicated eyewear has been proposed as a method for presenting a stereoscopic image, but in recent years, a stereoscopic display capable of presenting a stereoscopic image without using dedicated eyewear (hereinafter, referred to as a naked-eye stereoscopic display) has been proposed (see, for example, PTL 1).

In the naked-eye stereoscopic display, a plurality of images is guided to the left eye and the right eye of a user by using a lenticular lens or a parallax barrier, so that stereoscopic vision with images becomes possible (see, for example, PTL 2).

### Citation List

### Patent Literature

PTL 1: WO 2018/116580 A
PTL 2: JP 2012-169858 A

### SUMMARY OF INVENTION

### Technical Problem

Meanwhile, in a naked-eye stereoscopic display system, the amount of data of handled images is larger than that in a 2D display system according to the related art, and thus, in a case of simply performing necessary processing, the processing efficiency of the system may deteriorate. Therefore, a proposal for implementing system optimization has been demanded.

The present disclosure has been made to solve such a problem described above and enables implementation of system optimization.

### Solution to Problem

An image processing apparatus according to one aspect of the present disclosure is an image processing apparatus including: a processing unit that performs processing in such a way that a processing load for a second signal related to a second stereoscopic image presented at a second viewpoint position away from a first viewpoint position is lower than a processing load for a first signal related to a first stereoscopic image presented at the first viewpoint position corresponding to a position of a user viewing a stereoscopic image in a real space, among a plurality of viewpoint positions which are relative positions with respect to a stereoscopic display configured to present a plurality of images as the stereoscopic image.

An image processing method according to one aspect of the present disclosure is an image processing method executed by an image processing apparatus, the image processing method including: performing processing in such a way that a processing load for a second signal related to a second stereoscopic image presented at a second viewpoint position away from a first viewpoint position is lower than a processing load for a first signal related to a first stereoscopic image presented at the first viewpoint position corresponding to a position of a user viewing a stereoscopic image in a real space, among a plurality of viewpoint positions which are relative positions with respect to a stereoscopic display configured to present a plurality of images as the stereoscopic image.

A recording medium according to one aspect of the present disclosure is a recording medium having a program recorded therein, the program causing a computer to function as an image processing apparatus including: a processing unit that performs processing in such a way that a processing load for a second signal related to a second stereoscopic image presented at a second viewpoint position away from a first viewpoint position is lower than a processing load for a first signal related to a first stereoscopic image presented at the first viewpoint position corresponding to a position of a user viewing a stereoscopic image in a real space, among a plurality of viewpoint positions which are relative positions with respect to a stereoscopic display configured to present a plurality of images as the stereoscopic image.

In an image processing apparatus, an image processing method, and a recording medium according to one aspect of the present disclosure, a processing load for a second signal related to a second stereoscopic image presented at a second viewpoint position away from a first viewpoint position is lower than a processing load for a first signal related to a first stereoscopic image presented at the first viewpoint position corresponding to a position of a user viewing a stereoscopic image in a real space, among a plurality of viewpoint positions which are relative positions with respect to a stereoscopic display configured to present a plurality of images as the stereoscopic image.

Note that the image processing apparatus according to one aspect of the present disclosure may be an independent apparatus or an internal block included in one apparatus.

### BRIEF DESCRIPTION OF DRAWINGS

FIG. 1 is a block diagram illustrating an example of a configuration according to an embodiment of a stereoscopic display system to which the present disclosure is applied.

FIG. 2 is a diagram for explaining a stereoscopic image presented by a stereoscopic display of FIG. 1.

FIG. 3 is a block diagram illustrating a first example of a functional configuration of the stereoscopic display system of FIG. 1.

FIG. 4 is a block diagram illustrating a second example of the functional configuration of the stereoscopic display system of FIG. 1.

FIG. 5 is a block diagram illustrating a third example of the functional configuration of the stereoscopic display system of FIG. 1.

FIG. 6 is a block diagram illustrating a fourth example of the functional configuration of the stereoscopic display system of FIG. 1.

FIG. 7 is a block diagram illustrating a fifth example of the functional configuration of the stereoscopic display system of FIG. 1.

FIG. 8 is a block diagram illustrating a sixth example of the functional configuration of the stereoscopic display system of FIG. 1.

FIG. 9 is a diagram illustrating an example of a configuration of a UI unit that receives preference of a user.

FIG. 10 is a flowchart illustrating a flow of processing performed by the stereoscopic display system.

FIG. 11 is a block diagram illustrating an example of another configuration according to an embodiment of a stereoscopic display system to which the present disclosure is applied.

FIG. 12 is a block diagram illustrating an example of another configuration according to an embodiment of a stereoscopic display system to which the present disclosure is applied.

FIG. 13 is a block diagram illustrating an example of a configuration of a computer.

### DESCRIPTION OF EMBODIMENTS

### System Configuration

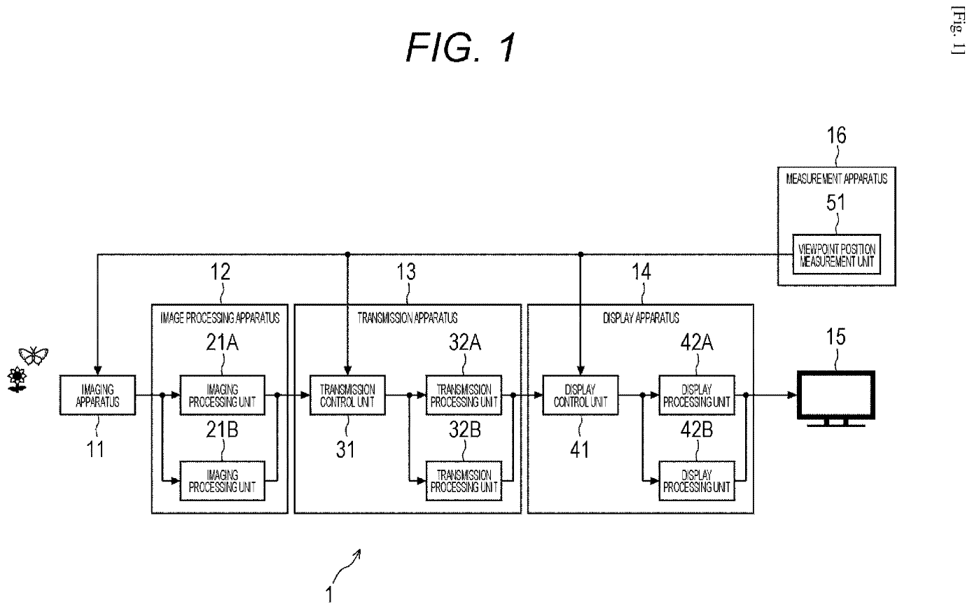

FIG. 1 is a block diagram illustrating an example of a configuration according to an embodiment of a stereoscopic display system to which the present disclosure is applied.

In FIG. 1, a stereoscopic display system 1 is a naked-eye stereoscopic display system that presents a stereoscopic image by a naked-eye stereoscopic display. The stereoscopic display system 1 includes an imaging apparatus 11, an image processing apparatus 12, a transmission apparatus 13, a display apparatus 14, a stereoscopic display 15, and a measurement apparatus 16.

The imaging apparatus 11 includes a camera or the like capable of capturing a plurality of images for presenting a stereoscopic image. The imaging apparatus 11 supplies an imaging signal obtained by imaging a subject to the image processing apparatus 12. Furthermore, the imaging apparatus 11 generates an imaging processing instruction on the basis of viewpoint position information input from the measurement apparatus 16, and supplies the imaging processing instruction to the image processing apparatus 12.

The viewpoint position is a relative position with respect to the stereoscopic display 15 that presents the stereoscopic image. The viewpoint position information includes information regarding a viewpoint position corresponding to a position of a user (viewer) viewing the stereoscopic image presented on the stereoscopic display 15 in the real space, among viewpoint positions. The viewpoint position information may indicate a three-dimensional viewpoint position in the real space not only with three-dimensional or one-dimensional coordinates, but also with another coordinate system. The imaging processing instruction is an instruction for imaging processing in the subsequent stage, and is an instruction for adjusting (changing) imaging processing in such a way that the system is optimized (improved in efficiency) according to the viewpoint position of the user.

The image processing apparatus 12 includes equipment such as a personal computer (PC) or a device including a field programmable gate array (FPGA). The image processing apparatus 12 includes an imaging processing unit 21A and an imaging processing unit 21B. The imaging signal and the imaging processing instruction from the imaging apparatus 11 are supplied to the image processing apparatus 12.

The imaging processing unit 21A performs first imaging processing on the imaging signal on the basis of the imaging processing instruction. The imaging processing unit 21B performs second imaging processing on the imaging signal on the basis of the imaging processing instruction. The imaging signal subjected to the imaging processing by the imaging processing unit 21A and the imaging processing unit 21B is output to the transmission apparatus 13.

Examples of the first imaging processing and the second imaging processing include signal processing such as demosaic processing, noise reduction (NR) processing, and super-resolution processing. For example, in the first imaging processing and the second imaging processing, the same type of processing (demosaic processing or the like) is performed, but processing loads (processing amounts in high-precision processing, simplified processing, and the like) are different. More specifically, high-precision demosaic processing is performed in the first imaging processing, and simplified demosaic processing is performed in the second imaging processing.

Note that the first imaging processing and the second imaging processing are not limited to the same type of processing, and different types of processing may be performed as long as the processing amount can be reduced. Furthermore, three or more imaging processings may be performed without being limited to the first imaging processing and the second imaging processing, as will be described in detail later.

The transmission apparatus 13 includes an apparatus such as a PC. The transmission apparatus 13 includes a transmission control unit 31, a transmission processing unit 32A, and a transmission processing unit 32B. The viewpoint position information from the measurement apparatus 16 and the imaging signal from the imaging apparatus 11 are input to the transmission control unit 31.

The transmission control unit 31 generates a transmission processing instruction on the basis of the viewpoint position information, and supplies the transmission processing instruction to the transmission processing unit 32A and the transmission processing unit 32B. The transmission processing instruction is an instruction for transmission processing in the subsequent stage, and is an instruction for adjusting (changing) transmission processing in such a way that the system is optimized according to the viewpoint position of the user. The transmission control unit 31 supplies, as a transmission signal, the imaging signal from the imaging apparatus 11 to the transmission processing unit 32A and the transmission processing unit 32B.

The transmission processing unit 32A performs first transmission processing on the transmission signal on the basis of the transmission processing instruction. The transmission processing unit 32B performs second transmission processing on the transmission signal on the basis of the transmission processing instruction. The transmission signal subjected to the transmission processing by the transmission processing unit 32A and the transmission processing unit 32B is transmitted to the display apparatus 14 via a transmission path.

Examples of the first transmission processing and the second transmission processing include signal processing such as bit rate transmission processing of changing a transmission bit rate of compression processing. For example, in the first transmission processing and the second transmission processing, the same type of processing (bit rate transmission processing or the like) is performed, but processing loads (data amounts such as a high bit rate and a low bit rate) are different. More specifically, in the first transmission processing, a bit rate transmission processing of changing the transmission bit rate to a higher bit rate is performed, and in the second transmission processing, a bit rate transmission processing of changing the transmission bit rate to a lower bit rate is performed.

Note that the first transmission processing and the second transmission processing are not limited to the same type of processing, and different types of processing may be performed as long as the data amount can be reduced. Furthermore, three or more transmission processings may be performed without being limited to the first transmission processing and the second transmission processing, as will be described in detail later.

The display apparatus 14 includes an apparatus such as a PC. The display apparatus 14 includes a display control unit 41, a display processing unit 42A, and a display processing unit 42B. The viewpoint position information from the measurement apparatus 16 and the transmission signal transmitted from the transmission apparatus 13 are input to the display control unit 41.

The display control unit 41 generates a display processing instruction on the basis of the viewpoint position information, and supplies the display processing instruction to the display processing unit 42A and the display processing unit 42B. The display processing instruction is an instruction for display processing in the subsequent stage, and is an instruction for adjusting (changing) display processing in such a way that the system is optimized according to the viewpoint position of the user. The display control unit 41 supplies, as a display signal, the transmission signal from the transmission apparatus 13 to the display processing unit 42A and the display processing unit 42B.

The display processing unit 42A performs first display processing on the display signal on the basis of the display processing instruction. The display processing unit 42B performs second display processing on the display signal on the basis of the display processing instruction. The display signal subjected to the display processing by the display processing unit 42A and the display processing unit 42B is output to the stereoscopic display 15.

Examples of the first display processing and the second display processing include signal processing such as noise reduction processing, scaler processing, and super-resolution processing. For example, in the first display processing and the second display processing, the same type of processing (noise reduction processing or the like) is performed, but processing loads (processing amounts such as high-precision processing and simplified processing) are different. More specifically, high-precision noise reduction processing is performed in the first display processing, and simplified noise reduction processing is performed in the second display processing.

Note that the first display processing and the second display processing are not limited to the same type of processing, and different types of processing may be performed as long as the processing amount can be reduced. Three or more display processings may be performed without being limited to the first display processing and the second display processing.

The stereoscopic display 15 is implemented by a non-wearable display (naked-eye stereoscopic display) capable of presenting a stereoscopic image without using dedicated eyewear. The stereoscopic display 15 can implement naked-eye stereoscopic vision by using a method such as a lenticular lens method or a parallax barrier method. The stereoscopic display 15 presents a plurality of images as a stereoscopic image by displaying a display image based on the display signal input from the display apparatus 14. As the stereoscopic display 15 presents the stereoscopic image, a subject imaged by the imaging apparatus 11 is reproduced.

The measurement apparatus 16 includes a sensor that measures the viewpoint position of the user in the real space, a camera, a signal processing circuit, and the like. The measurement apparatus 16 may be an independent apparatus or an internal block included in the stereoscopic display 15. The measurement apparatus 16 includes a viewpoint position measurement unit 51. The viewpoint position measurement unit 51 measures the viewpoint position of the user viewing the stereoscopic image presented by the stereoscopic display 15, and outputs, as the viewpoint position information, the viewpoint position to the imaging apparatus 11, the transmission apparatus 13, and the display apparatus 14.

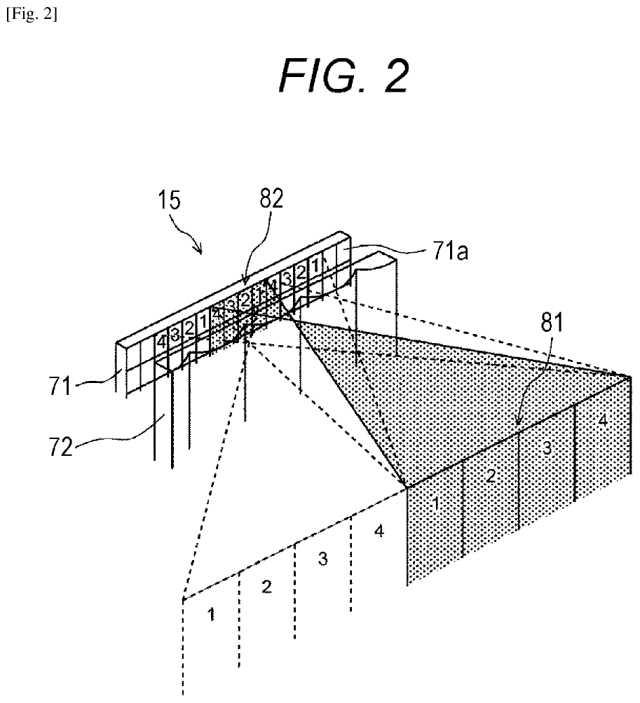

Here, the stereoscopic image presented by the stereoscopic display 15 will be described with reference to FIG. 2. In FIG. 2, the stereoscopic display 15 includes a display unit 71 and a lenticular lens 72. The display unit 71 is implemented by a liquid crystal display (LCD), an organic electro-luminescence (EL) panel, or the like. The lenticular lens 72 is an example of an optical isolation unit that isolates light from the display unit 71. Although not illustrated, a parallax element such as a parallax barrier may be used as the optical isolation unit.

In the example of FIG. 2, a display image 82 corresponding to a viewpoint image 81 of four viewpoints denoted by numbers 1 to 4 is periodically displayed in pixels 71a two-dimensionally arranged on the display unit 71. The lenticular lens 72 separates an image for the right eye and an image for the left eye in each display image 82. Since the user views each display image 82 through the lenticular lens 72, only the image for the right eye enters the right eye, and only the image for the left eye enters the left eye. In this way, the image seen by the right eye and the image seen by the left eye are different, so that the image displayed on the display unit 71 looks stereoscopic. In the example of FIG. 2, the stereoscopic image is presented by the viewpoint image 81 of four viewpoints corresponding to the repeatedly arranged display image 82.

In a case where the number of viewpoints is four, the display image 82 corresponding to the four viewpoints is periodically arranged at a position of each pixel of the display unit 71, and an image group of the four viewpoints is distributed to the display unit 71 including one display panel. The lenticular lens 72 arranged on a front surface of the display unit 71 spatially separates the display image 82 corresponding to the four viewpoints.

In the example of FIG. 2, the user views the stereoscopic image with the viewpoint image 81 of four viewpoints, but it is assumed that the viewpoint position of the user is a viewpoint position corresponding to viewpoint images of viewpoints 2 and 3 among a plurality of viewpoint positions. At this time, the viewpoint position of the user is the viewpoint position corresponding to the viewpoint images of viewpoints 2 and 3 in the viewpoint image 81 of four viewpoints, while viewpoint positions corresponding to viewpoint images of viewpoints 1 and 4 are away from the viewpoint position of the user. In the viewpoint image 81 presented by the stereoscopic display 15, viewpoint images presented at positions away from the viewpoint position of the user (the viewpoint images of viewpoints 1 and 4) have little influence on a sense of resolution of the stereoscopic image viewed by the user.

By using such a fact, in the stereoscopic display system 1 of FIG. 1, processings with different processing loads are performed on a signal related to a stereoscopic image presented at the viewpoint position of the user (a stereoscopic image with the viewpoint images of viewpoints 2 and 3) and a signal related to a stereoscopic image presented at a position away from the viewpoint position of the user (a stereoscopic image with the viewpoint images of viewpoints 1 and 4), respectively. For example, system optimization is implemented by simplifying processing for the latter signal in each apparatus and making the processing load for the latter signal lower than the processing load for the former signal.

In the following description, among a plurality of viewpoint positions that are relative positions with respect to the stereoscopic display 15 that presents the stereoscopic image, a viewpoint position corresponding to the position of the user viewing the stereoscopic image in the real space is referred to as a corresponding viewpoint position, and a viewpoint position away from the corresponding viewpoint position is referred to as a peripheral viewpoint position. That is, the corresponding viewpoint position is a viewpoint position (first viewpoint position) corresponding to the viewpoint position of the user, and the peripheral viewpoint position is a viewpoint position (second viewpoint position) away from the viewpoint position of the user.

Here, in a case where an imaging system, a transmission system, and a display system are considered in the stereoscopic display system 1, the amount of data of a handled image increases as compared with a 2D display system. Therefore, in a case where image processing and the like necessary for the imaging system, the transmission system, and the display system are simply performed, there is a possibility that a processing speed is decreased, a hardware (HW) size is increased, and image quality is deteriorated due to an increase in image compression amount at the time of transmission.

Therefore, in the stereoscopic display system 1, each of the imaging apparatus 11, the transmission control unit 31 of the transmission apparatus 13, and the display control unit 41 of the display apparatus 14 gives, as feedback (F/B), the imaging processing instruction, the transmission processing instruction, or the display processing instruction to a processing unit in the subsequent stage according to the viewpoint position information measured by the viewpoint position measurement unit 51. Then, in the processing unit in the subsequent stage, the processing load of the processing related to the stereoscopic image is adjusted (changed) in units of pixels according to the F/B, so that the imaging processing, the transmission processing, and the display processing can be appropriately simplified. As a result, the system optimization can be implemented. The optimization means to suppress the decrease in processing speed, the increase in HW size, and the deterioration in image quality at the time of transmission described above. Note that the system can be optimized not only to reduce the processing cost as described above but also to improve the quality of the presented stereoscopic image as will be described in detail later.

Note that it is not necessary to adjust and simplify all the imaging processing, the transmission processing, and the display processing, and at least one processing may be adjusted and simplified. For example, a case where only the imaging processing and the display processing are adjusted and simplified, and the transmission processing is not adjusted is possible.

### First Example of Functional Configuration

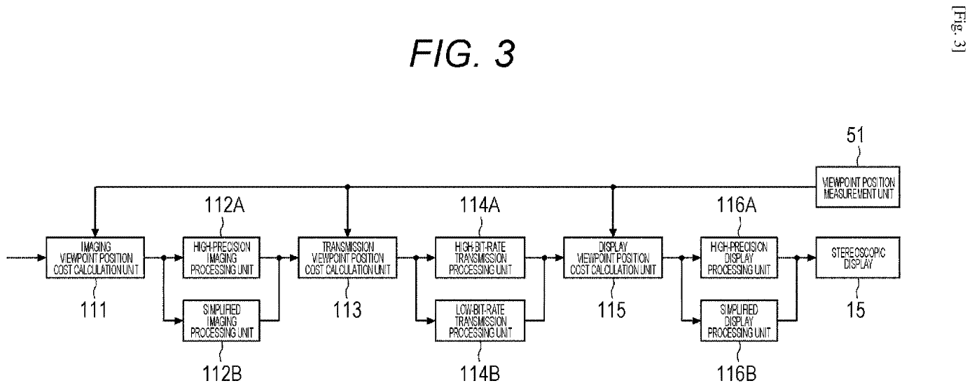

FIG. 3 is a block diagram illustrating a first example of a functional configuration of the stereoscopic display system of FIG. 1.

In FIG. 3, the stereoscopic display system 1 includes an imaging viewpoint position cost calculation unit 111, a high-precision imaging processing unit 112A, a simplified imaging processing unit 112B, a transmission viewpoint position cost calculation unit 113, a high-bit-rate transmission processing unit 114A, a low-bit-rate transmission processing unit 114B, a display viewpoint position cost calculation unit 115, a high-precision display processing unit 116A, and a simplified display processing unit 116B.

The imaging viewpoint position cost calculation unit 111 is included in the imaging apparatus 11 of FIG. 1. The high-precision imaging processing unit 112A and the simplified imaging processing unit 112B correspond to the imaging processing unit 21A and the imaging processing unit 21B of FIG. 1, and are included in the image processing apparatus 12 of FIG. 1.

The imaging viewpoint position cost calculation unit 111 calculates an imaging viewpoint position cost on the basis of the viewpoint position information from the viewpoint position measurement unit 51. The imaging viewpoint position cost calculation unit 111 supplies, as the imaging processing instruction, a result of calculating the imaging viewpoint position cost to the high-precision imaging processing unit 112A and the simplified imaging processing unit 112B.

In the calculation of the imaging viewpoint position cost, a viewpoint image of the corresponding viewpoint position and pixels allocated to (the display image corresponding to) the viewpoint image are associated with each other and ranked (here, for example, “rank A”). Furthermore, in the calculation of the imaging viewpoint position cost, a viewpoint image of the peripheral viewpoint position and pixels allocated to (the display image corresponding to) the viewpoint image are associated with each other and ranked (here, for example, “rank B”). Note that, in the ranking, a linear function can be used, but a nonlinear function may also be used.

As a result, the pixels 71a two-dimensionally arranged on the display unit 71 can be ranked as two ranks (rank A and rank B) for the pixels allocated to the viewpoint image of the corresponding viewpoint position and the pixels allocated to the viewpoint image of the peripheral viewpoint position. For example, in FIG. 2, in the viewpoint image 81 of four viewpoints, the viewpoint images of viewpoints 2 and 3 correspond to the viewpoint position of the user, and the viewpoint images of viewpoints 1 and 4 are away from the viewpoint position of the user. At this time, the pixels allocated to the viewpoint images of viewpoints 2 and 3 are ranked as rank A, and the pixels allocated to the viewpoint images of viewpoints 1 and 4 are ranked as rank B.

The high-precision imaging processing unit 112A performs high-precision imaging processing on the imaging signal corresponding to the pixels classified as rank A on the basis of the imaging processing instruction from the imaging viewpoint position cost calculation unit 111. The pixels allocated to the viewpoint image of the corresponding viewpoint position are classified as rank A.

The simplified imaging processing unit 112B performs simplified imaging processing on the imaging signal corresponding to the pixels classified as rank B on the basis of the imaging processing instruction from the imaging viewpoint position cost calculation unit 111. The pixels allocated to the viewpoint image of the peripheral viewpoint position are classified as rank B.

In the high-precision imaging processing and the simplified imaging processing, signal processing such as demosaic processing, noise reduction processing, or super-resolution processing is performed. As the demosaic processing, high-precision imaging processing is performed by performing processing using a nonlinear filter, a learning model trained by machine learning, or the like. As the trained model, a deep neural network (DNN) trained using learning data can be used. On the other hand, as the demosaic processing, simplified imaging processing is performed by performing processing using bilinear interpolation, nearest neighbor algorithm, or the like.

As the noise reduction processing, high-precision imaging processing is performed by performing processing using a nonlinear filter, a trained model, or the like. On the other hand, as the noise reduction processing, simplified imaging processing is performed by performing processing using simple addition or the like. As the super-resolution processing, high-precision imaging processing is performed by performing processing using a nonlinear filter, a trained model, or the like. On the other hand, as the super-resolution processing, simplified imaging processing is performed by performing processing using the Lanczos algorithm or the like. Note that, in the simplified imaging processing, the noise reduction processing and the super-resolution processing do not have to be performed.

In this manner, the calculation of the imaging viewpoint position cost based on the viewpoint position of the user is performed, and the high-precision imaging processing and the simplified imaging processing are switched according to the rank (rank A and rank B) obtained by the calculation of the imaging viewpoint position cost. That is, the imaging processing performed on the imaging signal corresponding to the pixels determined to have little influence on the sense of resolution according to the imaging processing instruction is simplified.

The transmission viewpoint position cost calculation unit 113, the high-bit-rate transmission processing unit 114A, and the low-bit-rate transmission processing unit 114B correspond to the transmission control unit 31, the transmission processing unit 32A, and the transmission processing unit 32B of FIG. 1, and are included in the transmission apparatus 13 of FIG. 1.

The transmission viewpoint position cost calculation unit 113 calculates a transmission viewpoint position cost on the basis of the viewpoint position information from the viewpoint position measurement unit 51. The transmission viewpoint position cost calculation unit 113 supplies, as the transmission processing instruction, a result of calculating the transmission viewpoint position cost to the high-bit-rate transmission processing unit 114A and the low-bit-rate transmission processing unit 114B.

Similarly to the calculation of the imaging viewpoint position cost described above, in the calculation of the transmission viewpoint position cost, the pixels are ranked as two ranks (rank A and rank B) for the pixels allocated to the viewpoint image of the corresponding viewpoint position and the pixels allocated to the viewpoint image of the peripheral viewpoint position.

The high-bit-rate transmission processing unit 114A performs high-bit-rate transmission processing of changing a transmission bit rate to a high bit rate on the transmission signal corresponding to the pixels classified as rank A on the basis of the transmission processing instruction from the transmission viewpoint position cost calculation unit 113.

The low-bit-rate transmission processing unit 114B performs low-bit-rate transmission processing of changing the transmission bit rate to a low bit rate on the transmission signal corresponding to the pixels classified as rank B on the basis of the transmission processing instruction from the transmission viewpoint position cost calculation unit 113. The changed low bit rate in the low-bit-rate transmission processing is lower than the changed high bit rate in the high-bit-rate transmission processing.

In this manner, the calculation of the transmission viewpoint position cost based on the viewpoint position of the user is performed, and the high-bit-rate transmission processing and the low-bit-rate transmission processing are switched according to the rank (rank A and rank B) obtained by the calculation of the transmission viewpoint position cost. That is, the bit rate of the transmission processing performed on the transmission signal corresponding to the pixels determined to have little influence on the sense of resolution according to the transmission processing instruction is lowered.

The display viewpoint position cost calculation unit 115, the high-precision display processing unit 116A, and the simplified display processing unit 116B correspond to the display control unit 41, the display processing unit 42A, and the display processing unit 42B of FIG. 1, and are included in the display apparatus 14 of FIG. 1.

The display viewpoint position cost calculation unit 115 calculates a display viewpoint position cost on the basis of the viewpoint position information from the viewpoint position measurement unit 51. The display viewpoint position cost calculation unit 115 supplies, as the display processing instruction, a result of calculating the display viewpoint position cost to the high-precision display processing unit 116A and the simplified display processing unit 116B.

Similarly to the calculation of the imaging viewpoint position cost described above, in the calculation of the display viewpoint position cost, the pixels are ranked as two ranks (rank A and rank B) for the pixels allocated to the viewpoint image of the corresponding viewpoint position and the pixels allocated to the viewpoint image of the peripheral viewpoint position.

The high-precision display processing unit 116A performs high-precision display processing on the display signal corresponding to the pixels classified as rank A on the basis of the display processing instruction from the display viewpoint position cost calculation unit 115.

The simplified display processing unit 116B performs simplified display processing on the display signal corresponding to the pixels classified as rank B on the basis of the display processing instruction from the display viewpoint position cost calculation unit 115.

In the high-precision display processing and the simplified display processing, signal processing such as noise reduction processing, scaler processing, or super-resolution processing is performed. As the noise reduction processing, high-precision display processing is performed by performing processing using a nonlinear filter, a trained model, or the like. On the other hand, as the noise reduction processing, simplified display processing is performed by performing processing using simple addition or the like.

As the scaler processing, high-precision display processing is performed by performing processing using a nonlinear filter, a trained model, or the like. On the other hand, as the scaler processing, simplified display processing is performed by performing processing using bilinear interpolation, nearest neighbor algorithm, or the like. As the super-resolution processing, high-precision display processing is performed by performing processing using a nonlinear filter, a trained model, or the like. On the other hand, as the super-resolution processing, simplified display processing is performed by performing processing using the Lanczos algorithm or the like. Note that, in the simplified display processing, the noise reduction processing, the scaler processing, and the super-resolution processing do not have to be performed.

In this manner, the calculation of the display viewpoint position cost based on the viewpoint position of the user is performed, and the high-precision display processing and the simplified display processing are switched according to the rank (rank A and rank B) obtained by the calculation of the display viewpoint position cost. That is, the display processing performed on the display signal corresponding to the pixels determined to have little influence on the sense of resolution according to the display processing instruction is simplified.

Note that, in the calculation of each viewpoint position cost, it is not always necessary to perform ranking in such a way that simplified processing is performed on a signal corresponding to the pixels allocated to the viewpoint image of the peripheral viewpoint position. For example, in the display processing, the final image quality may be maintained by performing ranking in such a way that high-precision display processing is performed on a signal sufficiently simplified in the imaging processing and the transmission processing.

### Second Example of Functional Configuration

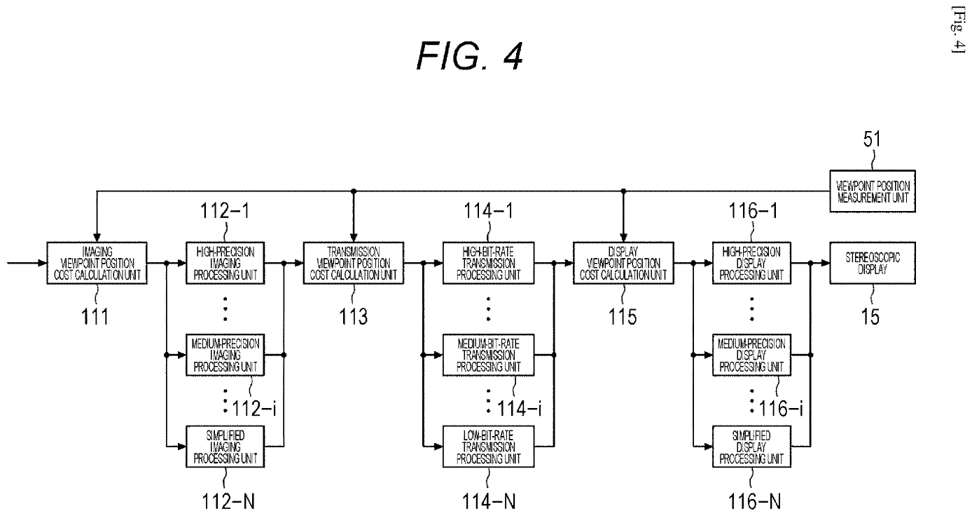

FIG. 4 is a block diagram illustrating a second example of the functional configuration of the stereoscopic display system of FIG. 1.

The configuration illustrated in FIG. 4 is a configuration in which the number of stages in each of the imaging processing, the transmission processing, and the display processing is increased from two to three or more according to the rank, as compared with the configuration illustrated in FIG. 3. In the configuration illustrated in FIG. 4, a high-precision imaging processing unit 112-1 to a simplified imaging processing unit 112-N including N stages (N: an integer of 3 or more) are provided instead of the high-precision imaging processing unit 112A and the simplified imaging processing unit 112B of FIG. 3.

The imaging viewpoint position cost calculation unit 111 calculates the imaging viewpoint position cost on the basis of the viewpoint position information, and supplies, as the imaging processing instruction, the calculation result to the high-precision imaging processing unit 112-1 to the simplified imaging processing unit 112-N.

For example, it is assumed that, among viewpoint images of six viewpoints, viewpoint images of viewpoints 3 and 4 at the center correspond to the viewpoint position of the user, and viewpoint images of viewpoints 1, 2, 5, and 6 are away from the viewpoint position of the user. At this time, in the calculation of the imaging viewpoint position cost, pixels allocated to the viewpoint images of viewpoints 3 and 4 are ranked as rank A, pixels allocated to the viewpoint images of viewpoints 2 and 5 are ranked as rank B, and pixels allocated to the viewpoint images of viewpoints 1 and 6 are ranked as rank C. Here, the viewpoint images of viewpoints 3 and 4 are at the corresponding viewpoint positions, and the viewpoint images of viewpoints 1, 2, 5, and 6 are at the peripheral viewpoint positions. However, the viewpoint images of viewpoints 1 and 6 are at the peripheral viewpoint positions more distant from the corresponding viewpoint positions than the viewpoint images of viewpoints 2 and 5 (away from the corresponding viewpoint positions).

The high-precision imaging processing unit 112-1 performs high-precision imaging processing such as demosaic processing using a nonlinear filter on the imaging signal corresponding to the pixels classified as rank A on the basis of the imaging processing instruction. The simplified imaging processing unit 112-N performs simplified imaging processing such as demosaic processing using bilinear interpolation on the imaging signal corresponding to the pixels classified as rank C on the basis of the imaging processing instruction.

The medium-precision imaging processing unit 112-i (1<i<N) performs medium-precision imaging processing on the imaging signal corresponding to the pixels classified as rank B on the basis of the imaging processing instruction. In the medium-precision imaging processing, imaging processing is performed with a precision between those of the high-precision imaging processing and the simplified imaging processing. For example, as stages whose number corresponds to the number of classes of a nonlinear filter are provided, in the medium-precision imaging processing, demosaic processing is performed with a precision lower than that in the high-precision imaging processing as the demosaic processing using the nonlinear filter. Alternatively, a DNN layer may have stages, or the number of taps of a filter for noise reduction (NR) may be changed in stages.

Although not illustrated, one or more imaging processing units may be further provided between the high-precision imaging processing unit 112-1 and the medium-precision imaging processing unit 112-i, and imaging processing may be performed in stages with a precision between those of the high-precision imaging processing and the medium-precision imaging processing. Furthermore, one or more imaging processing units may be further provided between the medium-precision imaging processing unit 112-i and the simplified imaging processing unit 112-N, and imaging processing may be performed in stages with a precision between those of the medium-precision imaging processing and the simplified imaging processing.

That is, in the three-stage imaging processing including the high-precision imaging processing, the medium-precision imaging processing, and the simplified imaging processing, the ranking is performed with three ranks, rank A to rank C, but N-stage imaging processing can be performed according to N ranks by performing the ranking with N ranks.

In the configuration illustrated in FIG. 4, a high-bit-rate transmission processing unit 114-1 to a low-bit-rate transmission processing unit 114-N including N stages are provided instead of the high-bit-rate transmission processing unit 114A and the low-bit-rate transmission processing unit 114B of FIG. 3.

The transmission viewpoint position cost calculation unit 113 calculates the transmission viewpoint position cost and supplies, as the transmission processing instruction, the calculation result to the high-bit-rate transmission processing unit 114-1 to the low-bit-rate transmission processing unit 114-N. Similarly to the calculation of the imaging viewpoint position cost described above, in the calculation of the transmission viewpoint position cost, the pixels allocated to the viewpoint images of viewpoints 3 and 4 are ranked as rank A, the pixels allocated to the viewpoint images of viewpoints 2 and 5 are ranked as rank B, and the pixels allocated to the viewpoint images of viewpoints 1 and 6 are ranked as rank C.

The high-bit-rate transmission processing unit 114-1 performs high-bit-rate transmission processing on the transmission signal corresponding to the pixels classified as rank A on the basis of the transmission processing instruction. The low-bit-rate transmission processing unit 114-N performs low-bit-rate transmission processing on the transmission signal corresponding to the pixels classified as rank C on the basis of the transmission processing instruction.

The medium-bit-rate transmission processing unit 114-i performs medium-bit-rate transmission processing on the transmission signal corresponding to the pixels classified as rank B on the basis of the transmission processing instruction. In the medium-bit-rate transmission processing, transmission processing of changing to a transmission bit rate between those of the high-bit-rate transmission processing and the low-bit-rate transmission processing is performed.

Although not illustrated, one or more transmission processing units may be further provided between the high-bit-rate transmission processing unit 114-1 and the medium-bit-rate transmission processing unit 114-i to perform transmission processing of changing to a transmission bit rate between those the high-bit-rate transmission processing and the medium-bit-rate transmission processing in stages. In addition, one or more transmission processing units may be further provided between the medium-bit-rate transmission processing unit 114-i and the low-bit-rate transmission processing unit 114-N to perform transmission processing of changing to a transmission bit rate between those of the medium-bit-rate transmission processing and the low-bit-rate transmission processing.

That is, in the three-stage transmission processing including the high-bit-rate transmission processing, the medium-bit-rate transmission processing, and the low-bit-rate transmission processing, the ranking is performed with three ranks, rank A to rank C, but N-stage transmission processing can be performed according to N ranks by performing the ranking with N ranks.

In the configuration illustrated in FIG. 4, a high-precision display processing unit 116-1 to a simplified display processing unit 116-N including N stages are provided instead of the high-precision display processing unit 116A and the simplified display processing unit 116B of FIG. 3.

The display viewpoint position cost calculation unit 115 calculates the display viewpoint position cost, and supplies, as the display processing instruction, the calculation result to the high-precision display processing unit 116-1 to the simplified display processing unit 116-N. Similarly to the calculation of the imaging viewpoint position cost described above, in the calculation of the display viewpoint position cost, the pixels allocated to the viewpoint images of viewpoints 3 and 4 are ranked as rank A, the pixels allocated to the viewpoint images of viewpoints 2 and 5 are ranked as rank B, and the pixels allocated to the viewpoint images of viewpoints 1 and 6 are ranked as rank C.

The high-precision display processing unit 116-1 performs high-precision display processing such as noise reduction processing using a nonlinear filter on the display signal corresponding to the pixels classified as rank A on the basis of the display processing instruction. The simplified display processing unit 116-N performs simplified display processing such as noise reduction processing using simple addition on the display signal corresponding to the pixels classified as rank C on the basis of the display processing instruction.

The medium-precision display processing unit 116-i performs medium-precision display processing on the display signal corresponding to the pixels classified as rank B on the basis of the display processing instruction. In the medium-precision display processing, display processing is performed with a precision between those of the high-precision display processing and the simplified display processing. For example, as stages whose number corresponds to the number of classes of a nonlinear filter are provided, in the medium-precision display processing, noise reduction processing is performed with a precision lower than that in the high-precision display processing as the noise reduction processing using the nonlinear filter. Alternatively, a DNN layer may have stages, or the number of taps of a filter for noise reduction (NR) may be changed in stages.

Although not illustrated, one or more display processing units may be further provided between the high-precision display processing unit 116-1 and the medium-precision display processing unit 116-i, and display processing may be performed in stages with a precision between those of the high-precision display processing and the medium-precision display processing. Furthermore, one or more display processing units may be further provided between the medium-precision display processing unit 116-i and the simplified display processing unit 116-N, and display processing may be performed in stages with a precision between those of the medium-precision display processing and the simplified display processing.

That is, in the three-stage display processing including the high-precision display processing, the medium-precision display processing, and the simplified display processing, the ranking is performed with three ranks, rank A to rank C, but N-stage display processing can be performed according to N ranks by performing the ranking with N ranks.

### Third Example of Functional Configuration

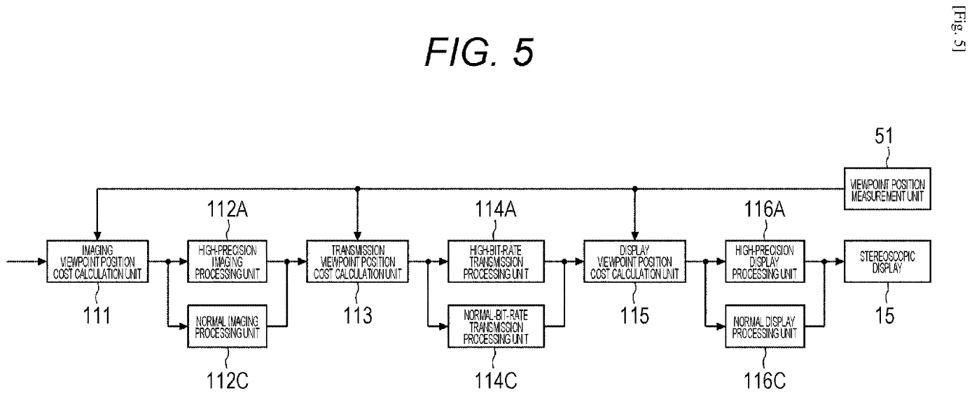

FIG. 5 is a block diagram illustrating a third example of the functional configuration of the stereoscopic display system of FIG. 1.

In the configuration illustrated in FIG. 5, instead of simplified processing, normal processing is performed for the imaging processing, the transmission processing, and the display processing to achieve further improvement in quality instead of simplification, unlike the configuration illustrated in FIG. 3. In the configuration illustrated in FIG. 5, a normal imaging processing unit 112C, a normal-bit-rate transmission processing unit 114C, and a normal display processing unit 116C are provided instead of the simplified imaging processing unit 112B, the low-bit-rate transmission processing unit 114B, and the simplified display processing unit 116B of FIG. 3.

The imaging viewpoint position cost calculation unit 111 calculates the imaging viewpoint position cost on the basis of the viewpoint position information, and supplies, as the imaging processing instruction, the calculation result to the high-precision imaging processing unit 112A and the normal imaging processing unit 112C. For example, in the calculation of the imaging viewpoint position cost, pixels allocated to viewpoint images of the corresponding viewpoint positions (for example, the viewpoint images of viewpoints 2 and 3 in FIG. 2) are ranked as rank A, and pixels allocated to viewpoint images of the peripheral viewpoint positions (for example, the viewpoint images of viewpoints 1 and 4 in FIG. 2) are ranked as rank B.

The normal imaging processing unit 112C performs normal imaging processing on the imaging signal corresponding to the pixels classified as rank B on the basis of the imaging processing instruction from the imaging viewpoint position cost calculation unit 111. The normal imaging processing is imaging processing performed with a precision that is lower than that of the high-precision imaging processing and is higher than that of the simplified imaging processing, and imaging processing such as demosaic processing using a nonlinear filter is performed.

In this manner, the high-precision imaging processing performed by the high-precision imaging processing unit 112A and the normal imaging processing performed by the normal imaging processing unit 112C are switched according to the rank (rank A and rank B) obtained by the calculation of the imaging viewpoint position cost.

The transmission viewpoint position cost calculation unit 113 calculates the transmission viewpoint position cost on the basis of the viewpoint position information, and supplies, as the transmission processing instruction, the calculation result to the high-bit-rate transmission processing unit 114A and the normal-bit-rate transmission processing unit 114C. Similarly to the calculation of the imaging viewpoint position cost described above, in the calculation of the transmission viewpoint position cost, the pixels allocated to the viewpoint images of the corresponding viewpoint positions (for example, viewpoint images of viewpoints 2 and 3 in FIG. 2) are ranked as rank A, and the pixels allocated to the viewpoint images of the peripheral viewpoint positions (for example, the viewpoint images of viewpoints 1 and 4 in FIG. 2) are ranked as rank B.

The normal-bit-rate transmission processing unit 114C performs normal-bit-rate transmission processing on the transmission signal corresponding to the pixels classified as rank B on the basis of the transmission processing instruction from the transmission viewpoint position cost calculation unit 113. The normal-bit-rate transmission processing is transmission processing of changing to a bit rate lower than the high bit rate and higher than the low bit rate.

In this manner, the high-bit-rate transmission processing performed by the high-bit-rate transmission processing unit 114A and the normal-bit-rate transmission processing performed by the normal-bit-rate transmission processing unit 114C are switched according to the rank (rank A and rank B) obtained by the calculation of the transmission viewpoint position cost.

The display viewpoint position cost calculation unit 115 calculates the display viewpoint position cost on the basis of the viewpoint position information, and supplies, as the display processing instruction, the calculation result to the high-precision display processing unit 116A and the normal display processing unit 116C. Similarly to the calculation of the imaging viewpoint position cost described above, in the calculation of the transmission viewpoint position cost, the pixels allocated to the viewpoint images of the corresponding viewpoint positions (for example, viewpoint images of viewpoints 2 and 3 in FIG. 2) are ranked as rank A, and the pixels allocated to the viewpoint images of the peripheral viewpoint positions (for example, the viewpoint images of viewpoints 1 and 4 in FIG. 2) are ranked as rank B.

The normal display processing unit 116C performs normal display processing on the display signal corresponding to the pixels classified as rank B on the basis of the display processing instruction from the display viewpoint position cost calculation unit 115. The normal display processing is display processing performs with a precision lower than that of the high-precision display processing and higher than that of the simplified display processing, and display processing such as noise reduction processing using a nonlinear filter is performed.

In this manner, the high-precision display processing performed by the high-precision display processing unit 116A and the normal display processing performed by the normal display processing unit 116C are switched according to the rank (rank A and rank B) obtained by the calculation of the display viewpoint position cost.

As described above, it is also possible to change the processing by the imaging system, the transmission system, and the display system not for the purpose of simplification but for achieving a high precision (high quality). In this case, the processing cost increases as compared with a case of performing the above-described simplified processing, but the quality of the presented stereoscopic image can be suitably improved.

### Fourth Example of Functional Configuration

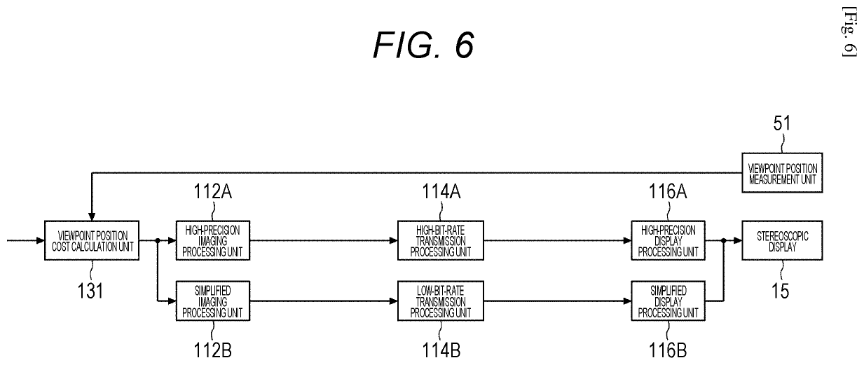

FIG. 6 is a block diagram illustrating a fourth example of the functional configuration of the stereoscopic display system of FIG. 1.

Unlike the configuration illustrated in FIG. 3, the configuration illustrated in FIG. 6 is a configuration in which the calculation of the viewpoint position cost necessary for each of the imaging processing, the transmission processing, and the display processing is collectively performed first, and the calculation of the viewpoint position cost in the subsequent stage is omitted. In the configuration illustrated in FIG. 6, a viewpoint position cost calculation unit 131 is provided instead of the imaging viewpoint position cost calculation unit 111, the transmission viewpoint position cost calculation unit 113, and the display viewpoint position cost calculation unit 115 of FIG. 3.

The viewpoint position cost calculation unit 131 calculates a viewpoint position cost on the basis of the viewpoint position information from the viewpoint position measurement unit 51. The viewpoint position cost calculation unit 131 sequentially supplies, as a processing instruction, a result of calculating the viewpoint position cost to a processing unit in the subsequent stage. For example, in the calculation of the viewpoint position cost, pixels allocated to the viewpoint images of the corresponding viewpoint positions (for example, the viewpoint images of viewpoints 2 and 3 in FIG. 2) are ranked as rank A, and pixels allocated to the viewpoint images of the peripheral viewpoint positions (for example, viewpoint images of viewpoints 1 and 4 in FIG. 2) are ranked as rank B.

In the high-precision imaging processing unit 112A and the simplified imaging processing unit 112B, imaging processing is performed on the basis of the processing instruction from the viewpoint position cost calculation unit 131. In the high-bit-rate transmission processing unit 114A and the low-bit-rate transmission processing unit 114B, transmission processing is performed on the basis of the processing instruction from the viewpoint position cost calculation unit 131. In the high-precision display processing unit 116A and the simplified display processing unit 116B, display processing is performed on the basis of the processing instruction from the viewpoint position cost calculation unit 131.

### Fifth Example of Functional Configuration

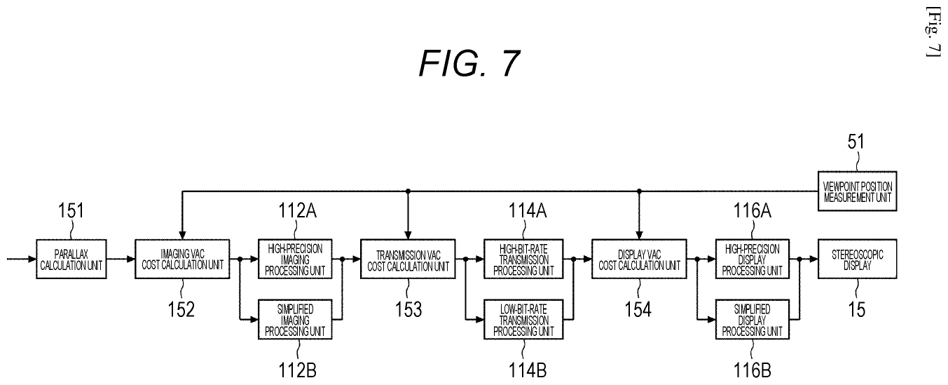

FIG. 7 is a block diagram illustrating a fifth example of the functional configuration of the stereoscopic display system of FIG. 1.

The configuration illustrated in FIG. 7 is a configuration considering vergence-accommodation conflict (VAC) unlike the configuration illustrated in FIG. 3. In presentation of a stereoscopic image, it is known that there is VAC which is a conflict between accommodation for the user's eye and vergence, and there is a risk of imposing a burden on the user due to eyestrain, sickness, or the like. In the configuration illustrated in FIG. 7, processing on a signal corresponding to a pixel is adjusted in a case where the stereoscopic image viewed by the user is inside a VAC region where the vergence-accommodation conflict occurs and in a case where the stereoscopic image is outside the VAC region.

In the configuration illustrated in FIG. 7, a parallax calculation unit 151, an imaging VAC cost calculation unit 152, a transmission VAC cost calculation unit 153, and a display VAC cost calculation unit 154 are provided instead of the imaging viewpoint position cost calculation unit 111, the transmission viewpoint position cost calculation unit 113, and the display viewpoint position cost calculation unit 115 of FIG. 3.

The parallax calculation unit 151 calculates a parallax amount on the basis of the imaging signal from the imaging apparatus 11, and supplies the parallax amount to the imaging VAC cost calculation unit 152. As a method of calculating the parallax amount, for example, the parallax amount between images can be obtained by performing image processing such as block matching using a G channel of the image captured by the imaging apparatus 11. The G channel is a channel corresponding to an image signal obtained from light transmitted through a filter corresponding to a green wavelength region.

The imaging VAC cost calculation unit 152 calculates an imaging VAC cost on the basis of the viewpoint position information and viewing distance information from the viewpoint position measurement unit 51 and the parallax amount from the parallax calculation unit 151, and supplies, as the imaging processing instruction, the calculation result to the high-precision imaging processing unit 112A and the simplified imaging processing unit 112B. Here, the viewpoint position measurement unit 51 measures a viewing distance from the stereoscopic display 15 and outputs the viewing distance to the imaging VAC cost calculation unit 152 in order to obtain the VAC region.

For example, in the calculation of the imaging VAC cost, the VAC region is obtained according to the parallax amount and the viewing distance, and ranking is performed in such a way that, among stereoscopic images presented at the viewpoint position of the user, pixels allocated to a stereoscopic image outside the VAC region are classified as rank A, and pixels allocated to a stereoscopic image inside the VAC region are classified as rank B.

The high-precision imaging processing unit 112A performs high-precision imaging processing on the imaging signal corresponding to the pixels classified as rank A on the basis of the imaging processing instruction from the imaging VAC cost calculation unit 152. The pixels corresponding to the viewpoint image outside the VAC region among the viewpoint images of the corresponding viewpoint positions are classified as rank A.

The simplified imaging processing unit 112B performs simplified imaging processing on the imaging signal corresponding to the pixels classified as rank B on the basis of the imaging processing instruction from the imaging VAC cost calculation unit 152. The pixels corresponding to the viewpoint image inside the VAC region among the viewpoint images of the corresponding viewpoint positions are classified as rank B. Furthermore, the pixels allocated to the viewpoint image of the peripheral viewpoint position are classified as rank B.

In this manner, as switching between the high-precision imaging processing and the simplified imaging processing is performed according to the rank (rank A and rank B) obtained according to the VAC region, the processing load of the imaging processing on the signal related to the stereoscopic image inside the VAC region that may impose a burden on the user becomes lower than that of the imaging processing on the signal related to the stereoscopic image outside the VAC region.

Similarly to the imaging VAC cost calculation unit 152, the transmission VAC cost calculation unit 153 and the display VAC cost calculation unit 154 calculate the VAC cost on the basis of the viewpoint position information, the viewing distance information, and the parallax amount. A description thereof will be omitted to avoid redundant explanation. The low-bit-rate transmission processing unit 114B performs low-bit-rate transmission processing on the transmission signal corresponding to the pixels classified as rank B on the basis of the transmission processing instruction from the transmission VAC cost calculation unit 153. The simplified display processing unit 116B performs simplified display processing on the display signals corresponding to the pixels classified as rank B.

### Sixth Example of Functional Configuration

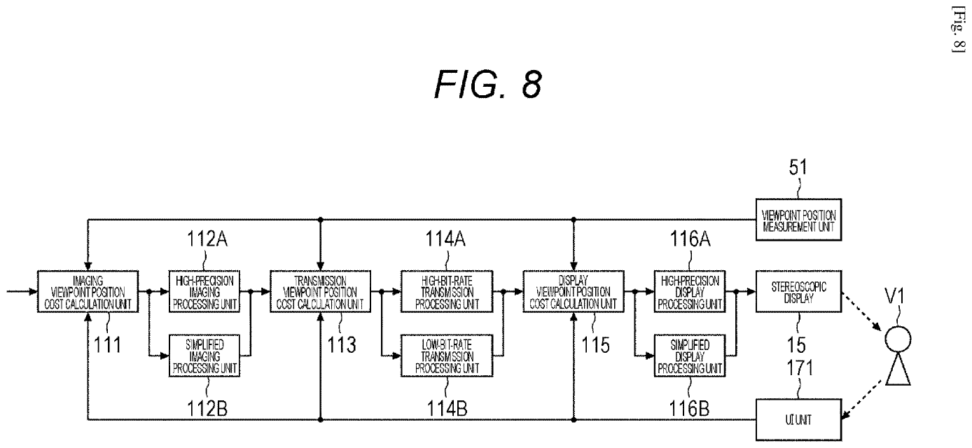

FIG. 8 is a block diagram illustrating a sixth example of the functional configuration of the stereoscopic display system of FIG. 1.

Unlike the configuration illustrated in FIG. 3, in the configuration illustrated in FIG. 8, the preference of the user is reflected in calculating the viewpoint position cost. Unlike the configuration illustrated in FIG. 3, in the configuration illustrated in FIG. 8, a UI unit 171 is further provided.

The UI unit 171 is a user interface (UI) that receives the preference of the user. The UI unit 171 receives a preference of a user V1 in accordance with an operation by the user V1. The UI unit 171 supplies received preference information regarding the preference of the user V1 to the imaging viewpoint position cost calculation unit 111, the transmission viewpoint position cost calculation unit 113, and the display viewpoint position cost calculation unit 115.

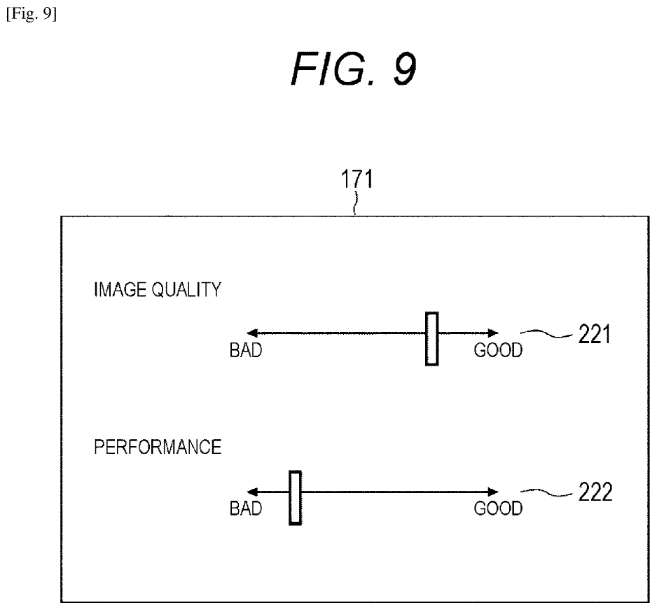

FIG. 9 is a diagram illustrating an example of the UI that receives the preference of the user V1. In FIG. 9, the UI unit 171 includes an image quality adjustment unit 221 and a performance adjustment unit 222. In the image quality adjustment unit 221, the user V1 moves a slider left and right to adjust the image quality of the stereoscopic image to a desired image quality. In the performance adjustment unit 222, the user V1 moves a slider left and right to adjust a presentation state of the stereoscopic image to a desired presentation state. In this manner, the user V1 evaluates the stereoscopic image viewed by the user V1 and inputs the evaluation result via the UI unit 171, so that the user V1 can reflect his/her preference.

Returning to FIG. 8, the imaging viewpoint position cost calculation unit 111 calculates the imaging viewpoint position cost on the basis of the viewpoint position information from the viewpoint position measurement unit 51 and the preference information from the UI unit 171. For example, in the calculation of the imaging viewpoint position cost, the preference information is reflected by weighting a function for performing ranking or the like. The imaging processing instruction reflecting the preference information is supplied to the high-precision imaging processing unit 112A and the simplified imaging processing unit 112B.

Similarly to the imaging viewpoint position cost calculation unit 111, the transmission viewpoint position cost calculation unit 113 and the display viewpoint position cost calculation unit 115 calculate the viewpoint position cost on the basis of the viewpoint position information and the preference information. A description thereof will be omitted to avoid redundant explanation.

Note that the UI unit 171 may be displayed on a display as a graphical user interface (GUI) or may be provided as an operation unit (a physical button or the like). Alternatively, the preference information may be acquired according to a speech input from the user. In the UI unit 171, a UI for adjustment of other parameters in addition to the adjustment of the image quality and the performance may be presented.

### Processing Flow

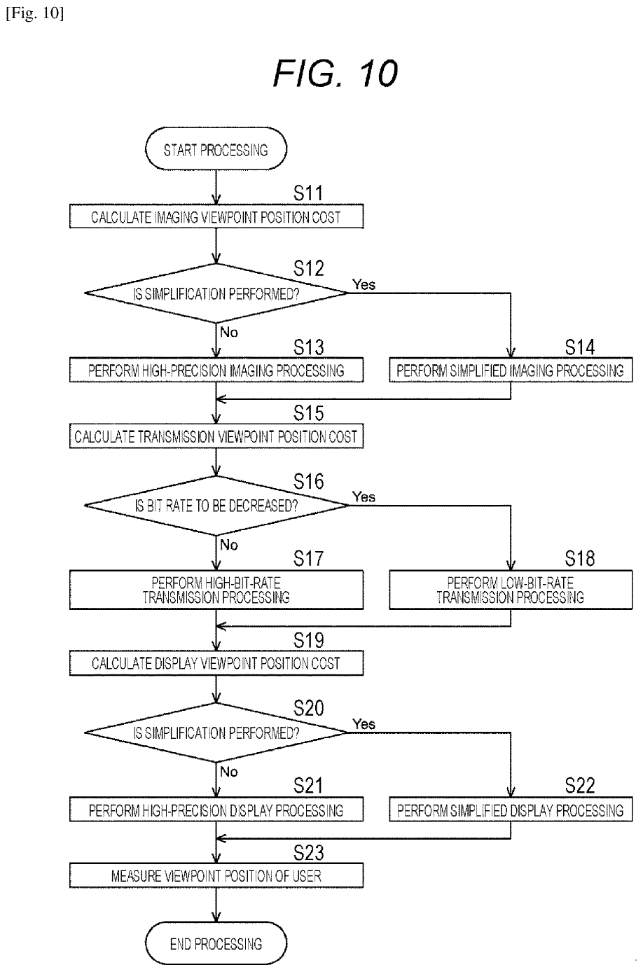

Next, a flow of processing performed by the stereoscopic display system 1 of FIG. 3 will be described with reference to a flowchart of FIG. 10.

In Step S11, the imaging viewpoint position cost calculation unit 111 calculates the imaging viewpoint position cost on the basis of the viewpoint position information. In a case where the simplification is not performed (S12: No), the high-precision imaging processing unit 112A performs high-precision imaging processing (S13). On the other hand, in a case where the simplification is performed (S12: Yes), the simplified imaging processing unit 112B performs simplified imaging processing (S14).

In Step S15, the transmission viewpoint position cost calculation unit 113 calculates the transmission viewpoint position cost on the basis of the viewpoint position information. In a case of increasing the bit rate (S16: No), the high-bit-rate transmission processing unit 114A performs high-bit-rate transmission processing (S17). On the other hand, in a case of decreasing the bit rate (S16: Yes), the low-bit-rate transmission processing unit 114B performs low-bit-rate transmission processing (S18).

In Step S19, the display viewpoint position cost calculation unit 115 calculates the display viewpoint position cost on the basis of the viewpoint position information. In a case where the simplification is not performed (S20: No), the high-precision display processing unit 116A performs high-precision display processing (S21). On the other hand, in a case where the simplification is performed (S20: Yes), the simplified display processing unit 116B performs simplified display processing (S22).

In Step S23, the viewpoint position measurement unit 51 measures the viewpoint position of the user. The viewpoint position information is output to the imaging viewpoint position cost calculation unit 111, the transmission viewpoint position cost calculation unit 113, and the display viewpoint position cost calculation unit 115, and is used for calculating each viewpoint position cost.

As described above, in the stereoscopic display system 1, the image processing apparatus 12, the transmission apparatus 13, and the display apparatus 14 include the processing units (the imaging processing units 21A and 21B, the transmission processing units 32A and 32B, and the display processing units 42A and 42B) that adjust the processing loads of the processings (the imaging processing, the transmission processing, and the display processing) related to the stereoscopic image according to the viewpoint position of the user. As described above, the processing load of the processing related to the stereoscopic image is adjusted according to the viewpoint position of the user, so that system optimization (efficiency improvement) can be implemented.

Meanwhile, in a case where the imaging system, the transmission system, and the display system are considered in the naked-eye stereoscopic display system, the amount of data of a handled image increases as compared with a 2D display system. Therefore, in a case where processing necessary for the imaging system, the transmission system, and the display system are simply performed, there is a possibility that a processing speed is decreased, an HW size is increased, and image quality is deteriorated due to an increase in image compression amount at the time of transmission. Even in the naked-eye stereoscopic display system, there is a need to maintain the HW size, the processing cost, and the image quality after compression, which is similar to the 2D display system.

For example, there is a method of suppressing the amount of image data to the same amount as that of the 2D display by setting a vertical resolution of each of captured images of two eyes (the image for the left eye and the image for the right eye) to ½ in response to such a need. However, in a case of using this method, a deterioration in image quality due to setting the resolution to ½ is caused. In addition, the existing method includes a method of suppressing the amount of data by cutting out a partial angle of view in an image and performing processing only in the range. In this case, however, there is a possibility that the image is difficult to be sufficiently cut out depending on the image. As a result, the processing cost is difficult to be reduced, and image quality may deteriorate or artifacts may occur in a case where the processing cost is reduced.

Therefore, in the present disclosure, the processing in the imaging system, the transmission system, and the display system is changed using the characteristics of the naked-eye stereoscopic display, thereby making the processing efficient without deteriorating the image quality. The processing cost can be reduced by detecting a portion where an influence of the characteristics of the naked-eye stereoscopic display on the image quality is little or a portion that does not need to be thoroughly reproduced, and giving the F/B to the imaging system, the transmission system, and the display system, or conversely, a high-quality stereoscopic image can be presented by performing high-precision processing on a portion important for the image quality.

Specifically, a three-dimensional viewpoint position of the user in the real space is acquired by performing measurement with, for example, a camera installed on a naked-eye stereoscopic display, and signal processing performed at the time of imaging, a bit rate of image compression, and display signal processing are changed according to the acquired viewpoint position, thereby improving the efficiency of the processing. Furthermore, the processing by the imaging system, the transmission system, and the display system changed in the present disclosure is not limited only to the purpose of reducing the processing cost, and can also be used, for example, for the purpose of obtaining a high-quality image by improving a precision in processing for a portion detected to be important for image quality due to characteristics of the naked-eye stereoscopic display. While the F/B described above is automatically calculated from the system by appropriate detection processing, it is also possible to take into account a subjective influence (preference) or the user.

### Modified Example

### Other Configuration Examples

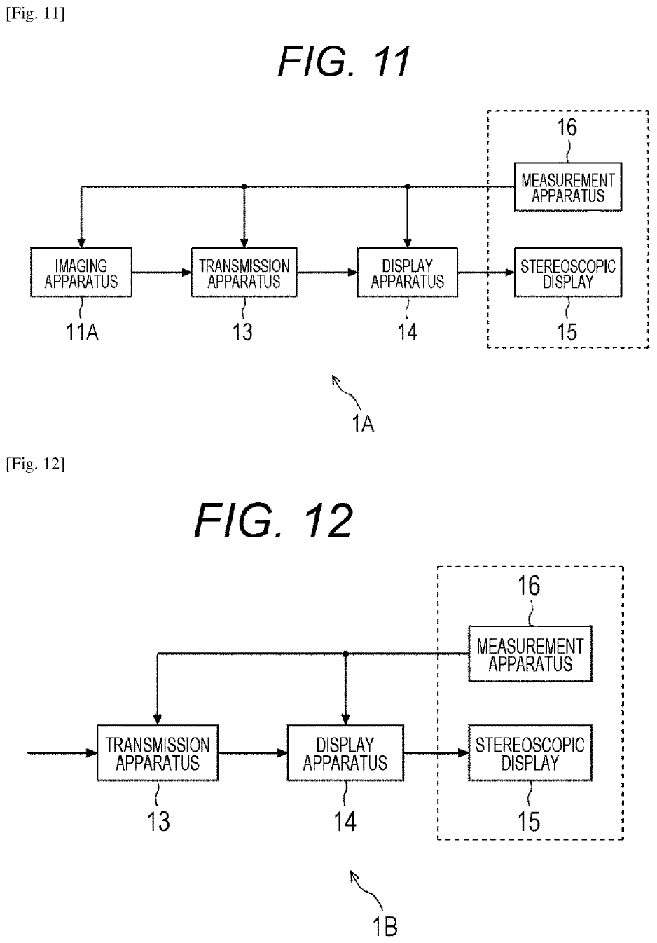

FIG. 11 is a block diagram illustrating an example of another configuration according to an embodiment of a stereoscopic display system to which the present disclosure is applied.

In FIG. 11, a stereoscopic display system 1A includes an imaging apparatus 11A, a transmission apparatus 13, a display apparatus 14, a stereoscopic display 15, and a measurement apparatus 16. The imaging apparatus 11A has the functions of the imaging apparatus 11 and the image processing apparatus 12 of FIG. 1. That is, the imaging apparatus 11A includes the imaging viewpoint position cost calculation unit 111, the high-precision imaging processing unit 112A, and the simplified imaging processing unit 112B of FIG. 3.

As described above, in each of the imaging system, the transmission system, and the display system, the viewpoint position cost calculation unit and the processing unit in the subsequent stage may be provided in the same apparatus or may be provided in different apparatuses, and a configuration corresponding to a variation thereof can be adopted. The image processing apparatus 12 or the imaging apparatus 11A and the transmission apparatus 13 may be configured by the same apparatus. Further, as surrounded by a broken line in the drawing, the stereoscopic display 15 and the measurement apparatus 16 may be configured by the same apparatus or may be configured by different apparatuses. Alternatively, the display apparatus 14 and the stereoscopic display 15 may be integrated and configured by the same apparatus.

FIG. 12 is a block diagram illustrating an example of another configuration according to an embodiment of a stereoscopic display system to which the present disclosure is applied.

In FIG. 12, a stereoscopic display system 1B includes a transmission apparatus 13, a display apparatus 14, a stereoscopic display 15, and a measurement apparatus 16. The configuration illustrated in FIG. 12 is different from the configuration illustrated in FIG. 1 in that the imaging apparatus 11 and the image processing apparatus 12 are not provided. That is, while FIG. 1 illustrates the configuration in which an image captured by the imaging apparatus 11 is live-distributed, FIG. 12 illustrates the configuration in which an image recorded in a storage apparatus is input to the transmission apparatus 13, and similar processing can also be performed on the recorded image in the transmission system and the display system.

Note that, in the stereoscopic display system 1 of FIG. 1, the imaging apparatus 11, the image processing apparatus 12, and the transmission apparatus 13 are installed on a distribution side, the display apparatus 14, the stereoscopic display 15, and the measurement apparatus 16 are installed on a terminal side, and an apparatus on the distribution side and an apparatus on the terminal side communicate with each other via a transmission path, so that various data can be exchanged. Examples of the transmission path include a communication path such as a communication line such as the Internet, an intranet, or a mobile communication network.

In the stereoscopic display system 1 of FIG. 1, the image processing apparatus 12, the transmission apparatus 13, and the display apparatus 14 are an example of the image processing apparatus to which the present disclosure is applied. In addition, a system including these apparatuses may be regarded as an image processing system. The system refers to a logical assembly of a plurality of apparatuses.

### Example of Another Method of Stereoscopic Vision

In the above description, the parallax barrier method and the lenticular lens method have been described as the methods for implementing the naked-eye stereoscopic vision. However, the present disclosure is not limited to these methods, and other methods may be used. Furthermore, the stereoscopic display 15 may be implemented by a naked-eye stereoscopic display using a stacked display panel, a tracking-type naked-eye stereoscopic display, or the like.

### Configuration of Computer

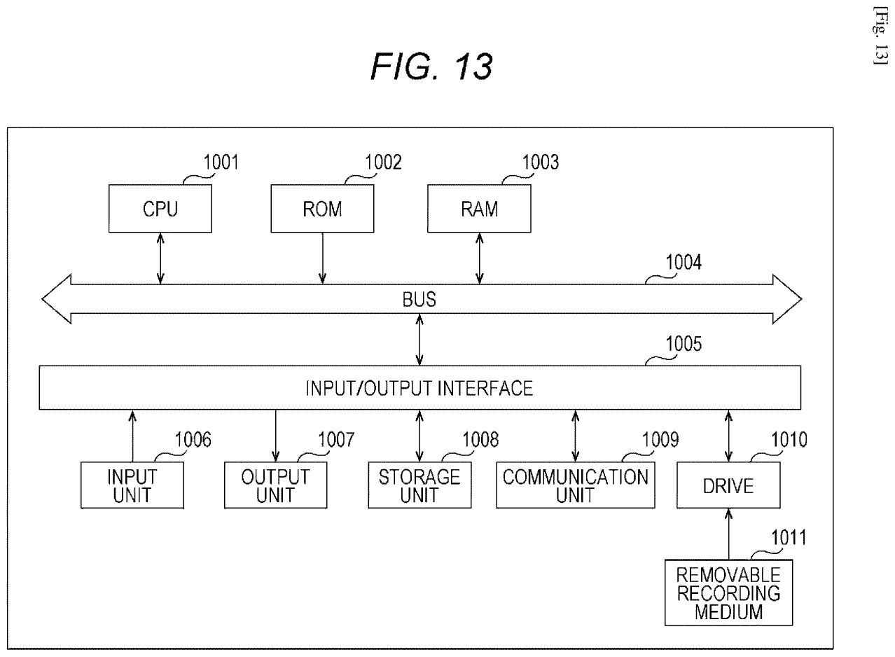

The series of processing described above can be performed by hardware or can be performed by software. In a case where the series of processing is performed by software, a program constituting the software is installed in a computer. FIG. 13 is a block diagram illustrating an example of a configuration of hardware of a computer performing the series of processing described above by using a program.

In a computer, a central processing unit (CPU) 1001, a read only memory (ROM) 1002, and a random access memory (RAM) 1003 are connected to one another by a bus 1004. Moreover, an input/output interface 1005 is connected to the bus 1004. An input unit 1006, an output unit 1007, a storage unit 1008, a communication unit 1009, and a drive 1010 are connected to the input/output interface 1005.

The input unit 1006 includes a keyboard, a mouse, a microphone, and the like. The output unit 1007 includes a display, a speaker, and the like. The storage unit 1008 includes a hard disk, a nonvolatile memory, and the like. The communication unit 1009 includes a network interface and the like. The drive 1010 drives a removable recording medium 1011 such as a semiconductor memory, a magnetic disk, an optical disk, or a magneto-optical disk.

In the computer configured as described above, the CPU 1001 loads a program recorded in the ROM 1002 or the storage unit 1008 to the RAM 1003 through the input/output interface 1005 and the bus 1004, and executes the program, such that the series of pieces of processing described above is performed.

The program executed by the computer (CPU 1001) can be provided by being recorded in the removable recording medium 1011 as a package medium or the like, for example. Furthermore, the program can be provided via a wired or wireless transmission medium such as a local area network, the Internet, or digital satellite broadcasting.

In the computer, the program can be installed in the storage unit 1008 via the input/output interface 1005 by mounting the removable recording medium 1011 on the drive 1010. Furthermore, the program can be received by the communication unit 1009 via a wired or wireless transmission medium and installed in the storage unit 1008. In addition, the program can be installed in the ROM 1002 or the storage unit 1008 in advance.

Here, in the present specification, the processing performed by the computer according to the program is not necessarily performed in time series in the order described as the flowchart. That is, the processing performed by the computer according to the program also includes processing performed in parallel or individually (for example, parallel processing or object-based processing). Furthermore, the program may be processed by one computer (processor) or may be processed in a distributed manner by a plurality of computers.

Note that the embodiment of the present disclosure is not limited to those described above, and may be variously changed without departing from the gist of the present disclosure. Furthermore, the effects described in the present specification are merely illustrative and not limitative, and the present disclosure may have other effects.

Furthermore, the present disclosure can also have the following configuration.
(1)

An image processing apparatus including:
a processing unit that performs processing in such a way that a processing load for a second signal related to a second stereoscopic image presented at a second viewpoint position away from a first viewpoint position is lower than a processing load for a first signal related to a first stereoscopic image presented at the first viewpoint position corresponding to a position of a user viewing a stereoscopic image in a real space, among a plurality of viewpoint positions which are relative positions with respect to a stereoscopic display configured to present a plurality of images as the stereoscopic image.
(2)

The image processing apparatus according to (1), in which
the processing unit performs second processing on the second signal, the second processing being simplified processing as compared with first processing for the first signal.
(3)

The image processing apparatus according to (2), in which
the processing unit simplifies the second processing in stages on the basis of the first viewpoint position.
(4)

The image processing apparatus according to (3), in which
the processing unit further simplifies the second processing as a distance of the presented second stereoscopic image from the first viewpoint position increases.
(5)

The image processing apparatus according to any one of (1) to (4), in which
first processing for the first signal and second processing for the second signal include at least one of imaging processing, transmission processing, or display processing, the imaging processing being processing related to imaging, the transmission processing being processing related to transmission, and the display processing being processing related to display.
(6)

The image processing apparatus according to (5), in which
the processing unit performs simplified imaging processing on the second signal.
(7)

The image processing apparatus according to (6), in which
the imaging processing includes at least one of signal processings including demosaic processing, noise reduction processing, and super-resolution processing, and
the processing unit performs, on the second signal, signal processing whose processing amount is smaller than that of signal processing for the first signal.
(8)

The image processing apparatus according to (5), in which
the processing unit performs, on the second signal, transmission processing whose transmission bit rate is lower than that of transmission processing for the first signal.
(9)

The image processing apparatus according to (5), in which
the processing unit performs simplified display processing on the second signal.
(10)

The image processing apparatus according to (9), in which
the display processing includes at least one of signal processings including noise reduction processing, scaler processing, and super-resolution processing, and
the processing unit performs, on the second signal, signal processing whose processing amount is smaller than that of signal processing for the first signal.
(11)

The image processing apparatus according to (1), in which
the processing unit performs, on the first signal, first processing with a precision higher than that of second processing for the second signal.
(12)

The image processing apparatus according to (1), in which
the processing unit performs third processing in which the processing load for the first signal in a case where the first stereoscopic image is present inside a VAC region where vergence-accommodation conflict occurs is lower than that in a case where the first stereoscopic image is present outside the VAC region.
(13)

The image processing apparatus according to any one of (1) to (4), in which
the stereoscopic display is a non-wearable display configured to present the stereoscopic image without using dedicated eyewear.
(14)

An image processing method executed by an image processing apparatus, the image processing method including:
performing processing in such a way that a processing load for a second signal related to a second stereoscopic image presented at a second viewpoint position away from a first viewpoint position is lower than a processing load for a first signal related to a first stereoscopic image presented at the first viewpoint position corresponding to a position of a user viewing a stereoscopic image in a real space, among a plurality of viewpoint positions which are relative positions with respect to a stereoscopic display configured to present a plurality of images as the stereoscopic image.
(15)

A recording medium having a program recorded therein, the program causing a computer to function as an image processing apparatus including:
a processing unit that performs processing in such a way that a processing load for a second signal related to a second stereoscopic image presented at a second viewpoint position away from a first viewpoint position is lower than a processing load for a first signal related to a first stereoscopic image presented at the first viewpoint position corresponding to a position of a user viewing a stereoscopic image in a real space, among a plurality of viewpoint positions which are relative positions with respect to a stereoscopic display configured to present a plurality of images as the stereoscopic image.
(1A)

An image processing apparatus including:
a processing unit that performs processing including
   first processing a first signal related to a first stereoscopic image at a first viewpoint position corresponding to a position of a user viewing a stereoscopic image in a real space, the first processing having a first processing load; and second processing a second signal related to a second stereoscopic image at a second viewpoint positioned away from the first viewpoint position, the second processing having a second load that is lower than the first processing load.
(13A)

The imaging processing apparatus according to any one of (1) to (12) or (1A), further including an imaging device configured to measure the plurality of viewpoint positions; and
a non-wearable display configured to present the stereoscopic image without using dedicated eyewear that serves as the stereoscope display,
wherein the imaging device is further configured to output viewpoint position information which is information of the plurality of viewpoint positions to the processing unit, and
wherein the first processing for the first signal and the second processing for the second signal each include at least one of imaging processing, transmission processing, or display processing, wherein the imaging processing is related to imaging, the transmission processing is related to transmission, and the display processing is related to display.
(14A)

An image processing method executed by an image processing apparatus, the image processing method including:
first processing a first signal related to a first stereoscopic image at a first viewpoint position corresponding to a position of a user viewing a stereoscopic image in a real space, the first processing having a first processing load; and second processing a second signal related to a second stereoscopic image at a second viewpoint position away from the first viewpoint position, the second processing having a second processing load that is lower than the first processing load.
(15A)

A recording medium having a program recorded therein, the program causing a computer to function as an image processing apparatus including:
first processing a first signal related to a first stereoscopic image at a first viewpoint position corresponding to a position of a user viewing a stereoscopic image in a real space, the first processing having a first processing load; and second processing a second signal related to a second stereoscopic image at a second viewpoint position away from the first viewpoint position, the second processing having a second processing load that is lower than the first processing load.

It should be understood by those skilled in the art that various modifications, combinations, sub-combinations and alterations may occur depending on design requirements and other factors insofar as they are within the scope of the appended claims or the equivalents thereof.

### Reference Signs List

1, 1A, 1B Stereoscopic display system
11, 11A Imaging apparatus
12 Image processing apparatus
13 Transmission apparatus
14 Display apparatus
15 Stereoscopic display
16 Measurement apparatus
21A, 21B Imaging processing unit
31 Transmission control unit
32A, 32B Transmission processing unit
41 Display control unit
42A, 42B Display processing unit
51 Viewpoint position measurement unit
111 Imaging viewpoint position cost calculation unit
112A, 112-1 High-precision imaging processing unit
112B, 112-N Simplified imaging processing unit
112-i Medium-precision imaging processing unit
112C Normal imaging processing unit
113 Transmission viewpoint position cost calculation unit
114A, 114-1 High-bit-rate transmission processing unit
114B, 114-N Low-bit-rate transmission processing unit
114-i Medium-bit-rate transmission processing unit
114C Normal-bit-rate transmission processing unit
115 Display viewpoint position cost calculation unit
116A, 116-1 High-precision display processing unit
116B, 116-N Simplified display processing unit
116-i Medium-precision display processing unit
116C Normal display processing unit
131 Viewpoint position cost calculation unit
151 Parallax calculation unit
152 Imaging VAC cost calculation unit
153 Transmission VAC cost calculation unit
154 Display VAC cost calculation unit
171 UI unit
1001 CPU

1. An image processing apparatus comprising:
a processing unit configured to perform processing including
first processing for a first signal related to a first stereoscopic image at a first viewpoint position corresponding to a position of a user viewing a stereoscopic image in a real space, among a plurality of viewpoints with respect to a stereoscopic display configured to present a plurality of images as the stereoscopic image, the first processing having a first processing load; and
second processing for a second signal related to a second stereoscopic image at a second viewpoint position away from the first viewpoint position, the second processing having a second load that is lower than the first processing load.

2. The image processing apparatus according to claim 1, wherein
the second processing is simplified as compared with the first processing.

3. The image processing apparatus according to claim 2, wherein
the processing unit is configured to simplify the second processing in stages on a basis of the first viewpoint position.

4. The image processing apparatus according to claim 3, wherein
the processing unit is further configured to simplify the second processing as a distance of the second viewpoint position from the first viewpoint position increases.

5. The image processing apparatus according to claim 1, wherein
the first processing for the first signal and the second processing for the second signal include at least one of imaging processing, transmission processing, or display processing, the imaging processing being processing related to imaging, the transmission processing being processing related to transmission, and the display processing being processing related to display.

6. The image processing apparatus according to claim 5, wherein
the processing unit is configured to perform simplified imaging processing on the second signal.

7. The image processing apparatus according to claim 6, wherein
the imaging processing includes at least one of signal processings including demosaic processing, noise reduction processing, and super-resolution processing, and
the processing unit is configured to perform, on the second signal, signal processing whose processing amount is smaller than that of signal processing for the first signal.

8. The image processing apparatus according to claim 5, wherein
the processing unit is configured to perform, on the second signal, transmission processing whose transmission bit rate is lower than that of transmission processing for the first signal.

9. The image processing apparatus according to claim 5, wherein
the processing unit is configured to perform simplified display processing on the second signal.

10. The image processing apparatus according to claim 9, wherein
the display processing includes at least one of signal processings including noise reduction processing, scaler processing, and super-resolution processing, and
the processing unit is configured to perform, on the second signal, signal processing whose processing amount is smaller than that of signal processing for the first signal.

11. The image processing apparatus according to claim 1, wherein
the processing unit is configured to perform, on the first signal, first processing with a precision higher than that of second processing for the second signal.

12. The image processing apparatus according to claim 1, wherein
the processing unit is configured to perform third processing in which a processing load for the first signal in a case where the first stereoscopic image is present inside a vergence-accommodation conflict (VAC) region where vergence-accommodation conflict occurs is lower than that in a case where the first stereoscopic image is present outside the VAC region.

13. The image processing apparatus according to claim 1, wherein
the stereoscopic display is a non-wearable display configured to present the stereoscopic image without using dedicated eyewear.

14. The image processing apparatus according to claim 13, wherein the image processing apparatus further comprises:
an imaging device configured to measure the plurality of viewpoint positions; and
the non-wearable display,
wherein the imaging device is further configured to output viewpoint position information which is information of the plurality of viewpoint positions to the processing unit, and
wherein the first processing for the first signal and the second processing for the second signal each include at least one of imaging processing, transmission processing, or display processing, wherein the imaging processing is related to imaging, the transmission processing related to transmission, and the display processing is related to display.

15. An image processing method executed by an image processing apparatus, the image processing method comprising:
first processing a first signal related to a first stereoscopic image at a first viewpoint position corresponding to a position of a user viewing a stereoscopic image in a real space, among a plurality of viewpoints with respect to a stereoscopic display configured to present a plurality of images as the stereoscopic image, the first processing having a first processing load; and
second processing a second signal related to a second stereoscopic image at a second viewpoint position away from the first viewpoint position, the second processing having a second processing load that is lower than the first processing load.

16. The image processing method according to claim 15, wherein the image processing method further comprises:
displaying the stereoscopic image on a non-wearable stereoscopic display configured to present the stereoscopic image without using dedicated eyewear.

17. The image processing method according to claim 16, wherein the image processing method further comprises:
measuring the plurality of viewpoint positions relative to the non-wearable stereoscopic display; and
wherein the first processing for the first signal and the second processing for the second signal each include at least one of imaging processing, transmission processing, or display processing, wherein the imaging processing is related to imaging, the transmission processing is related to transmission, and the display processing is related to display.

18. A recording medium having a program recorded therein, the program causing a computer to function as an image processing apparatus including:
first processing for a first signal related to a first stereoscopic image at a first viewpoint position corresponding to a position of a user viewing a stereoscopic image in a real space, among a plurality of viewpoints with respect to a stereoscopic display configured to present a plurality of images as the stereoscopic image, the first processing having a first processing load; and
second processing for a second signal related to a second stereoscopic image at a second viewpoint position away from the first viewpoint position, the second processing having a second processing load that is lower than the first processing load.

19. The recording medium according to claim 18, wherein the program causing the computer to function as the image processing apparatus further comprises:
displaying of the stereoscopic image on a non-wearable stereoscopic display configured to present the stereoscopic image without using dedicated eyewear.

20. The recording medium according to claim 19, wherein the program causing the computer to function as the image processing apparatus including further comprises:
measuring of the plurality of viewpoint positions relative to the non-wearable stereoscopic display; and
wherein the first processing for the first signal and the second processing for the second signal each include at least one of imaging processing, transmission processing, or display processing, wherein the imaging processing is related to imaging, the transmission processing is related to transmission, and the display processing is related to display.
